(19) United States
(12) Patent Application Publication
(10) Pub. No.: US 2010/0131464 A1
(43) Pub. Date: May 27, 2010

(54) METHOD AND APPARATUS FOR ENABLING SIMULTANEOUS REPRODUCTION OF A FIRST MEDIA ITEM AND A SECOND MEDIA ITEM

(75) Inventors: Gijs Geleijnse, Eindhoven (NL); Johannes Henricus Maria Korst, Eindhoven (NL); Dragan Sekulovski, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/532,210

(22) PCT Filed: Mar. 18, 2008
(86) PCT No.: PCT/IB08/51013

§ 371 Date: Sep. 21, 2009

(30) Foreign Application Priority Data
Mar. 21, 2007 (EP) 07104558.7

(51) Int. Cl. G06F 17/00

(52) U.S. Cl. 707/611; 707/E17.009

(57) ABSTRACT

First and second media items are synchronized (step 210) on the basis of an extracted data item(s). A plurality of second media items are retrieved (step 206), returned, and selected (step 208) to be reproduced at the same time as occurrence of the extracted data item(s) during reproduction of the first media item.

### FIELD OF THE INVENTION

The present invention relates to method and apparatus for enabling simultaneous reproduction of a first media item and a second media item.

### BACKGROUND OF THE INVENTION

Media items are reproduced for the benefit of a viewer and can provide both visual and audio stimulation. Some media items, such as an audio track (e.g. a song) provide only audio stimulation and sometimes, to increase the enjoyment to the viewer, it is desirable to provide visual stimulation as well as audio.

Many systems exist for providing images, still or video clips, to be reproduced whilst listening to the reproduction of a piece of music, or a song. The images are displayed as the music is played back. Invariably, the images are selected to be related to the subject of the song, for example, associated with lyrics or metadata.

In “Google-based information extraction”, G. Geleijnse, J. Korst, and V. Pronk, Proceedings of the 6th Dutch-Belgian Information Retrieval Workshop (DIR 2006), Delft, the Netherlands, March 2006, a method is presented to automatically extract information using a search engine. This is implemented with automatically extracted biographies on famous people. Images that were displayed with each entry are automatically extracted from the Web. In this way, images are semantically related by the text.

Other known systems, such as the example found in “A personalized music video creator”, D. A. Shamma, B. Pardo, and K. J. Hammond. Musicstory, MULTIMEDIA '05: Proceedings of the 13th annual ACM international conference on Multimedia, pages 563-566, New York, N.Y., USA, 2005. ACM Press also automatically retrieves and display images from the lyrics of a song. Each word in the lyrics, apart from very common words (like ‘the’, ‘an’, ‘all’), is placed in an ordered list. All words in the lists are sent as queries to a search engine such as Google or Yahoo!. Images returned by this service are displayed in the same order as the corresponding terms.

However, the problem with the latter system is that it does not increase the enjoyment of the viewer as much as expected.

### SUMMARY OF THE INVENTION

The present invention seeks to provide a method and apparatus for enabling simultaneous reproduction of a first media item and a second media item, which increases the enjoyment of a user reproducing said media items.

This is achieved, according to an aspect of the present invention, by a method for synchronizing a first media item and a second media item, the method comprising the steps of: extracting at least one data item from data relating to a first media item; selecting at least one second media item on the basis of the extracted at least one data item; synchronizing the first media item and the selected at least one second media item such that the selected at least one second media item is reproduced at the same time as occurrence of the extracted at least one data item during reproduction of the first media item. Said data relating to said first media item may be part of the first media item or stored separate from the first media item.

This is also achieved according to a second aspect of the present invention, by apparatus for synchronizing a first media item and a second media item, the apparatus comprising: an extractor for extracting a data item from data relating to a first media item; a selector for selecting at least one second media item on the basis of the extracted data item; a synchronizer for synchronizing the first media item and the selected at least one second media item such that the selected at least one second media item is reproduced at the same time as occurrence of the extracted data item during reproduction of the first media item.

In this way, the first media item is synchronized with the second media item. For example, if the first media item was a song and the second media items were still or video images, the song and the images are synchronized such that when a lyric is sung, the corresponding image is reproduced.

In an embodiment of the present invention, the step of extracting at least one data item from data relating to a first media item comprises the step of: extracting the at least one data item from text data relating to the first media item.

According to such an embodiment of the present invention, the text data includes a plurality of words and phrases and wherein the step of extracting the at least one data item from text data relating to the first media item comprises the step of: extracting at least one of a word or phrase from the plurality of words and phrases.

In a preferred method according to such an embodiment of the present invention, the text data comprises at least one of a proper name, noun or verb.

According to such an embodiment of the present invention, the step of extracting at least one of a word or phrase from the plurality of words and phrases comprises the steps of: identifying the role of each of the plurality of words; and extracting a phrase from the plurality of words on the basis of the identified role of the plurality of words. In this way, whole phrases can be extracted. In other words, multiple terms such as “Rows of Houses” or “High Tech Campus” are recognized, which leads to more relevant images being extracted.

In an alternative embodiment of the present invention, the step of extracting at least one data item from data relating to a first media item comprises the steps of: determining the frequency of occurrence of each data item of said data relating to said first media item; and extracting the less frequently used data item of said data relating to said first media item. In this way, more relevant data items are extracted. For example, if the data items consisted of words, the most frequently used words such as “the”, “it”, “he”, “a”, would not be extracted, only the more relevant words would be extracted, leading to more relevant images.

In another embodiment of the present invention, the step of extracting at least one data item from data relating to a first media item comprises the step of: extracting a plurality of data items from a portion of said data of said first media item; and the step of selecting at least one second media item on the basis of the extracted at least one data item comprises the steps of: retrieving a plurality of second media items on the basis of each of the plurality of extracted data items; and selecting the most relevant of the retrieved second media items for each of the plurality of extracted data items.

In a preferred method according to such an embodiment of the present invention, the step of extracting a plurality of data items from a portion of said data of said first media item further comprises the step of: prioritizing the plurality of data items on the basis of one of the criteria of name, noun, verbs, or length. In this way, the more significant data items can be extracted.

In another embodiment of the present invention, the step of selecting the at least one second media item on the basis of the extracted at least one data item comprises the steps of: dividing the first media item into at least one segment; selecting a plurality of second media items on the basis of said at least one data item extracted from said data relating to said at least one segment; determining the time duration of the reproduction of each of the plurality of second media items; determining the time duration of the at least one segment; and selecting the number of the plurality of second media items to be reproduced within the segment. In this way, an optimum number of second media items can be reproduced within each segment.

In another embodiment of the present invention, the method further comprises the step of: identifying a dominant color in the selected at least one second media item. In this way, the most relevant color to the second media items and thus to the first media item is identified. For example, if the first media item were a song, the color most relevant to the lyrics or the topic of the song would be identified.

According to such an embodiment of the present invention, the step of synchronizing the first media item and the selected at least one second media item comprises the step of: synchronizing the first media item and the identified dominant color such that the identified dominant color is displayed at the same time as occurrence of the extracted at least one data item during reproduction of the first media item. In this way, the most relevant color is displayed at the same time stamp as the corresponding data item is reproduced.

In an alternative embodiment of the present invention, the method further comprises the step of: manually defining a mapping of a color to the extracted at least one data item.

According to such an embodiment of the present invention, the step of synchronizing the first media item and the selected at least one second media item comprises the step of: synchronizing the first media item and the defined mapping of color such that the defined mapping of color is displayed at the same time as occurrence of the extracted at least one data item during reproduction of the first media item.

As the first media item is reproduced the colors may change and these transitions between different colors are preferably smooth so as to be visually more pleasing to the user.

According one embodiment of the present invention, the first media item and the second media item is one of an audio data stream, a video data stream, image data, or color data.

### BRIEF DESCRIPTION OF THE DRAWINGS

For a more complete understanding of the present invention, reference is made to the following description in conjunction with the accompanying drawings, in which:

FIG. 1 is a simplified schematic of apparatus according to an embodiment of the present invention;

FIG. 2 is a flowchart of a method for enabling simultaneous reproduction of a first media item and a second media item according to an embodiment of the present invention;

FIG. 3 is a flowchart of a process of retrieving the most relevant second media items according to an embodiment of the present invention; and

FIG. 4 is a flowchart of a method for enabling reproduction of a first media item and a color according to another embodiment of the present invention.

### DETAILED DESCRIPTION OF EMBODIMENTS OF THE INVENTION

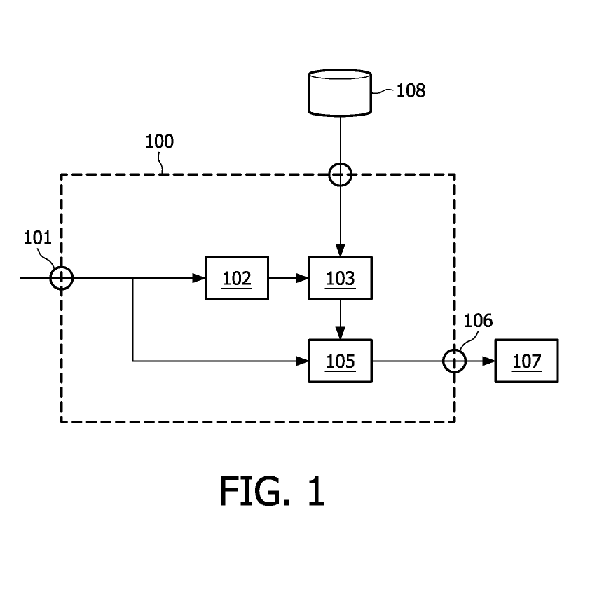

With reference to FIG. 1, the apparatus 100 of an embodiment of the present invention comprises an input terminal 101 for input of a first media item. The input terminal 101 is connected to an extractor 102. The output of the extractor 102 is connected to a selector 103 for retrieving and selecting second media item(s) from a storage means 108. The storage means may comprise, for example, a database on a local disk drive, or a database on a remote server. The storage means 108 may be accessed via a dedicated network or via the Internet. The output of the selector 103 is connected to a synchronizer 105. The synchronizer 105 is also connected to the input terminal 101. The output of the synchronizer is connected to an output terminal 106 of the apparatus 100. The output terminal 106 is connected to a rendering device 107. The apparatus 100 may be, for example, a consumer electronic device, e.g. a Television or a PC. The storage means 108 may be, for example, a hard disk, an optical disc unit or solid state memory. The input terminal 101, the extractor 102, the selector 103 and the synchronizer 105 may be functions implemented in software, for example.

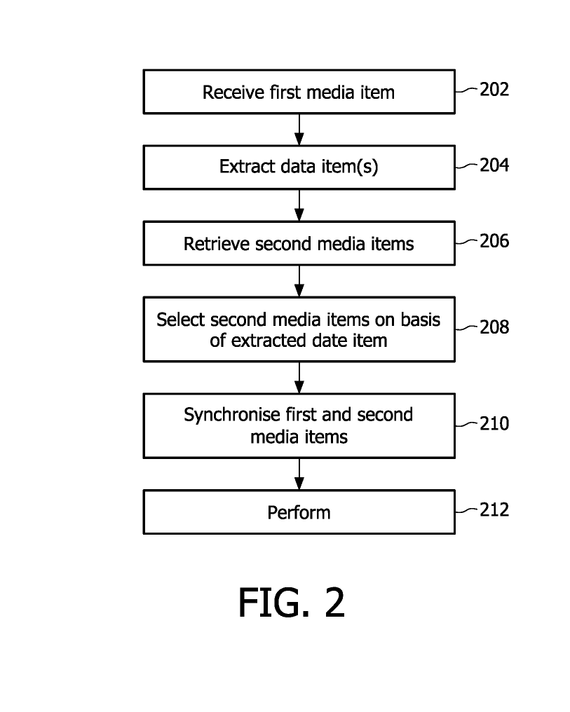

Operation of the apparatus 100 of FIG. 1 will now be described with reference to FIGS. 2 to 4. A first media item is input on the input terminal 101, step 202 of FIG. 2, and hence the extractor 102. The first media item may be, for example, an audio data stream, a video data stream, an image data, or a color data. The extractor 102 extracts at least one data item from the first media item, step 204.

The data item may be extracted from text data (i.e. a plurality of words and phrases) associated with the first media item, for example lyrics associated with a song. The extracted data item would then comprise words or phrases consisting of proper names, nouns or verbs.

Proper names may be, for example, “George W. Bush”, “High Tech Campus”. The proper names determine the topic of a text and are well suited to be represented by an image or images. These named-entities can be extracted using known techniques and applications. Examples of such techniques and applications can be found in “A Maximum Entropy Approach to Named Entity Recognition”, A. Brothwick, PhD thesis, New York University, 1999, and in “Named entity recognition using an hmm-based chunk tagger”, G. Zhou and J. Su, Proceedings of the 40^{th} Annual Meeting of the Association for Computational Linguistics (ACL 2002), pages 473-480, Philadelphia, Pa., 2002, and in “A framework and graphical development environment for robust nlp tools and applications”, H. Cunningham, D. Maynard, K. Bontcheva, and V. Tablan, Proceedings of the 40^{th} Annual Meeting of the Association for Computational Linguistics (ACL 2002), Philadelphia, Pa., 2002. It will be understood that the extraction techniques and applications are not limited to the examples provided. Other well-suited alternatives may be employed, such as extracting sequences of capitalized words.

Noun phrases may be extracted, for example, “big yellow taxi” and “little red corvette”. A noun phrase may be extracted from a plurality of words by firstly identifying the role of each of the plurality of words (for example, verb, noun, adjective). The role in the text of each word may be identified by using a “Part-of-Speech Tagger”, such as that described in “A simple rule-based part-of-speech tagger”, E. Brill, Proceedings of the third Conference on Applied Natural Language Processing (ANLP'92), pages 152-155, Trento, Italy, 1992. A phrase can then be extracted from the plurality of words on the basis of the identified role of the plurality of words. Alternatively, regular expressions of parts of speech may be formulated to extract noun phrases from a text. For example, an adverb followed by a positive number of adjectives, followed by a positive number of nouns (Adv•Adj⁺•Noun⁺) is a regular expression describing a term, as disclosed in “Automatic recognition of multi-word terms: the c-value/nc-value method”, K. Frantzi, S. Ananiado, and H. Mima, International Journal on Digital Libraries, 3:115-130, 2000.

Verbs may be, for example, “skiing”, “driving”, “inventing”. The Part-of-Speech Tagger may be used to identify verbs in a sentence. Copulas such as “to like”, “to be”, “to have”, can be omitted using a tabu-list.

There are a number of possible methods that can be used for extracting a data item from the first media item in step 204, according to the present invention.

One such method uses a statistical approach to extract a data item. In such a method, the data item is extracted by determining the frequency of occurrence of each data item of the first media item. For example, it is assumed the first media item includes text and the data item is a word. In such an example, a training corpus (a large representative text) is used to gather the frequencies of all word sequences occurring in the text. This approach is used for single word terms (1-grams), terms consisting of two words (2-grams), and generally N-grams (where N is typically 4 at most). An example of such an approach can be found in “Foundations of Statistical Natural Language Processing”, C. D. Manning and H. Schiitze, The MIT Press, Cambridge, Mass., 1999. In such an approach, the most frequently occurring N-grams (for example “is”, “he”, “it”) are known as stop words that are not useful to be selected as terms. Once the frequency of occurrence of each data item of the first media item has been determined, the less frequently used data item of the first media item is then extracted.

In another method for extracting a data item from a first media item according to the present invention, a lower and an upper frequency threshold is assigned and the terms between these thresholds are extracted, step 204. The terms between the upper and lower frequency thresholds are phrases that are well suited to be used to generate images.

Another technique for extracting data items (step 204) is to extract the data items and prioritize them on the basis of one of the criteria of names, nouns, verbs or length. For example, if the data items were phrases, they could be prioritized based on length, the longer phrases would be prioritized over the shorter phrases since the longer phrases are considered the more significant.

The extracted data item is output from the extractor 102 and input into the selector 103. The selector 103 accesses the storage means 108 and retrieves at least one second media item, audio data streams, video data streams, image data, or color data, on the basis of the extracted data item, step 206.

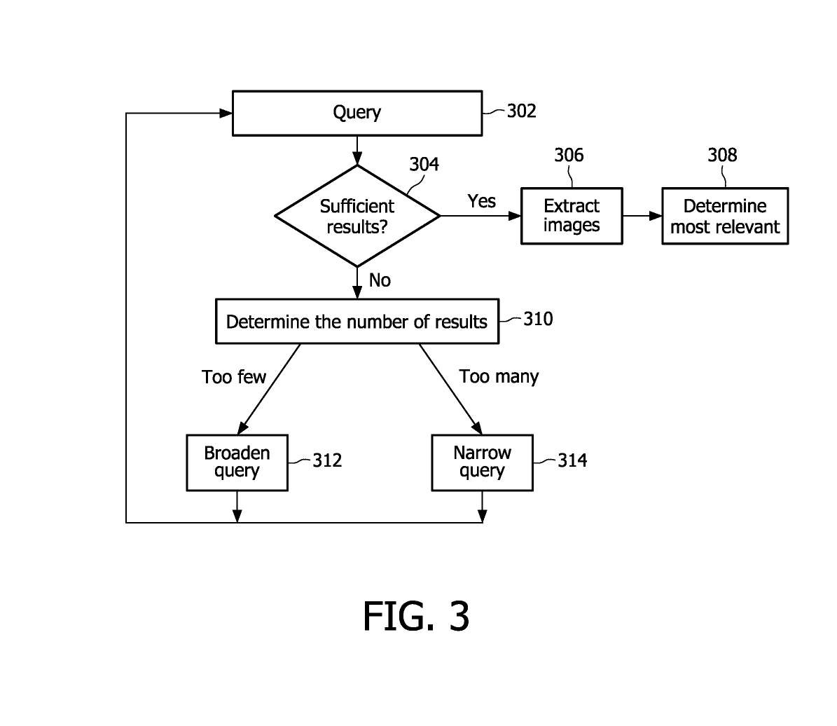

An example of the process of retrieving the most relevant second media items (step 206 of FIG. 2) will now be described in more detail with reference to FIG. 3. For the purpose of a clear description, it is assumed that the extracted data items are phrases and that the second media items to be retrieved are images. In this example, the second media items are retrieved from a public indexed repository of images (for example, “Google Images”). In other words, the storage means 108 is accessed via the Internet. It is to be understood that a public indexed repository is used purely as an example. A local repository, such as a private collection of indexed images, may also be used.

Firstly, for each phrase p the repository for “p” is queried via the Internet, step 302. The quotation marks inform the indexed repository to search for the complete phrase. It is then determined if the search engine has returned a sufficient number of results, step 304. If it is determined that the search engine has returned a sufficient number of results, then the images that have been found are extracted and presented, step 306.

However, if the query does not result in a sufficient number of results, the number of results is determined, step 310.

If it is determined that there are too few results (i.e. not enough results), then the query is broadened, step 312. The query may be broadened by, for example, removing the quotation marks and querying for p (so that each word in the phrase is searched separately), or by removing the first word in p. The first word in p is assumed to be the least relevant term. Once the query has been broadened, the query is repeated, step 302.

On the other hand, if it is determined that there are too many results (for example, if the indexed repository returns many hits), the query is narrowed, step 314. The query may be narrowed, for example, by combining successive phrases. Once the query has been narrowed, the query is repeated, step 302.

The process is repeated until the search engine returns a sufficient number of results. Once a sufficient number of results are returned, the images that have been found are extracted and presented by the indexed repository, step 306. The images presented can then be analyzed to determine the most relevant images per query, step 308. For example, the most relevant image is likely to be one that appears on multiple sites. Therefore, it is determined which image appears on the most sites and these are selected and returned.

In another method the second media items are selected as follows. The first media item is divided into segments and a plurality of second media items (for example, images) is then retrieved on the basis of the extracted data item for each segment, step 208. It is then possible to select a number of second media items to be reproduced within the segment. This is achieved by determining the time duration of the reproduction of each of the plurality of second media items and the time duration of the segment. The number of the plurality of second media items to be reproduced within the segment is then selected based on the time duration of the segment divided by the time duration of the reproduction of the plurality of second media items.

Once the second media items have been selected, this selection is input into the synchronizer 105. The first media item input on the input terminal 101 is also input into the synchronizer 105. The synchronizer 105 synchronizes the first media item and the selected second media item(s) such that a selected second media item is reproduced at the same time as occurrence of the corresponding extracted data item during reproduction of the first media item, step 210. In this way, for example, an automatic video-clip can be made in which selected images are displayed at the same time as occurrence of the corresponding lyric of a song during reproduction of that song.

After synchronization, the output of the synchronizer 105 is output onto the output terminal 106 and reproduced on a rendering device 107, such as a computer screen, projector, TV, colored lamps in combination with speakers etc.

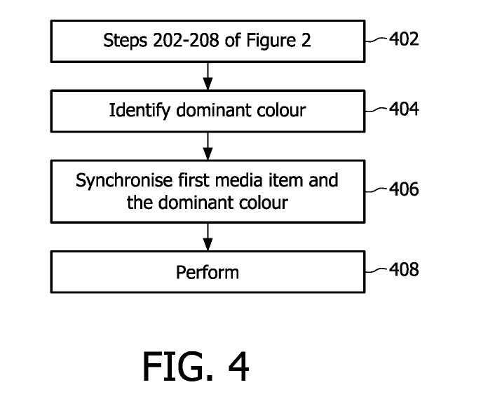

An alternative embodiment of the present invention will now be described with reference to FIG. 4. In the alternative embodiment of the present invention, the selected second media items can be further used to create light effects that match the topic of the first media item. For example, if the first media item is a song and the second media items are images, then the images can be used to create light effects that match the topic of the song.

According to the alternative embodiment of the present invention, steps 202 to 208 of FIG. 2 are first carried out (step 402).

Next, the selector 103 identifies a dominant color in the selected second media items, step 404. For example, if the extracted second media items are images, a dominant color is identified from the images. Then, if the song relates to the sea, for example, blue colors will dominate the images and will therefore be identified.

Once the dominant color has been identified at step 404, it is input into the synchronizer 105. The synchronizer 105 synchronizes the first media item and the identified dominant color such that the identified dominant color is displayed at the same time as occurrence of the extracted data item during reproduction of the first media item, step 406. The identified dominant color can be used in AmbiLight applications where colored lamps enhance an audio. It is to be understood that the synchronization of the first media item and the selected second media items discussed previously can further be used for the timing of the colors to be displayed. For example, a dominant color of blue may be identified from the second media items retrieved for a first extracted data item and a dominant color of red may be identified from the second media items retrieved for a second extracted data item. In such a case, the color blue will be displayed at the same time as occurrence of the first extracted data item and the color red will be displayed at the same time as occurrence of the second extracted data item, during reproduction of the first media item.

Alternatively, a mapping of color may be manually defined to the extracted data item. In this case, the step of identifying a dominant color from a set of second media items (step 404) is omitted for a predetermined number of extracted data items in the first media item. Instead, a mapping of color is manually defined for the predetermined number of extracted data items. For example, if the predetermined extracted data items are words such as “purple” or “Ferrari”, a mapping to the color that people relate to the words can be manually defined at step 404.

Once the mapping of color has been defined at the selector 103, it is input into the synchronizer 105. The synchronizer 105 synchronizes the first media item and the defined mapping of color such that the defined mapping of color is displayed at the same time as occurrence of the extracted data item during reproduction of the first media item, step 406.

After synchronization, the output of the synchronizer 105 is output onto the output terminal 106 and reproduced on the rendering device 107, step 408.

As the first media item is reproduced the colors change. This transition between different colors is preferably smooth so as to be visually more pleasing to the user.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for enabling simultaneous reproduction of a first media item and a second media item, the method comprising the steps of:
extracting at least one data item from data relating to a first media item;
selecting at least one second media item on the basis of said extracted at least one data item; and
synchronizing said first media item and said selected at least one second media item such that said selected at least one second media item is reproduced at the same time as occurrence of said extracted at least one data item during reproduction of said first media item.

2. A method according to claim 1, wherein the step of extracting at least one data item from data relating to a first media item comprises the step of:
extracting said at least one data item from text data relating to said first media item.

3. A method according to claim 2, wherein said text data includes a plurality of words and phrases and wherein the step of extracting said at least one data item from text data relating to said first media item comprises the step of:
extracting at least one of a word or phrase from said plurality of words and phrases.

4. A method according to claim 3, wherein said text data comprises at least one of a proper name, noun or verb.

5. A method according to claim 3, wherein the step of extracting at least one of a word or phrase from said plurality of words and phrases comprises the steps of:
identifying the role of each of said plurality of words; and
extracting a phrase from said plurality of words on the basis of said identified role of said plurality of words.

6. A method according to claim 1, wherein the step of extracting at least one data item from data relating to a first media item comprises the steps of:
determining the frequency of occurrence of each data item of said data relating to said first media item; and
extracting the less frequently used data item of said data relating to said first media item.

7. A method according to claim 1 wherein the step of extracting at least one data item from data relating to a first media item comprises the step of
extracting a plurality of data items from a portion of said data relating to said first media item; and wherein
the step of selecting at least one second media item on the basis of said extracted at least one data item comprises the steps of:
retrieving a plurality of second media items on the basis of each of said plurality of extracted data items; and
selecting the most relevant of said retrieved second media items for each of said plurality of extracted data items.

8. A method according to claim 1, wherein the step of selecting said at least one second media item on the basis of said extracted at least one data item comprises the steps of:
dividing said first media item into at least one segment;
retrieving a plurality of second media items on the basis of said at least one data item extracted from data relating to said at least one segment;
determining the time duration of the reproduction of each of said plurality of second media items;
determining the time duration of said at least one segment; and
selecting a number of said plurality of second media items to be reproduced within said segment.

9. A method according to claim 1, further comprising the step of:
identifying a dominant color in said selected at least one second media item.

10. A method according to claim 9, wherein the step of synchronizing said first media item and said selected at least one second media item comprises the step of:
synchronizing said first media item and said identified dominant color such that said identified dominant color is displayed at the same time as occurrence of said extracted at least one data item during reproduction of said first media item.

11. A method according to claim 1, further comprising the step of:
manually defining a mapping of a color to said extracted at least one data item.

12. A computer program product comprising a plurality of program code portions for carrying out the method according to claim 1.

13. Apparatus for enabling simultaneous reproduction of a first media item and a second media item, the apparatus comprising:
an extractor for extracting at least one data item from data relating to a first media item;
a selector for selecting at least one second media item on the basis of said extracted at least one data item; and
a synchronizer for synchronizing said first media item and said selected at least one second media item such that said selected at least one second media item is reproducing at the same time as occurrence of said extracted at least one data item during reproduction of said first media item.

14. Apparatus according to claim 13, wherein the extractor comprises means for extracting said at least one data item from text data relating to said first media item.
